(19) United States
(12) Patent Application Publication
(10) Pub. No.: US 2024/0058945 A1
(43) Pub. Date: Feb. 22, 2024

(54) SCARA ROBOT

(71) Applicant: FANUC CORPORATION, Minamitsuru-gun, Yamanashi (JP)

(72) Inventor: Yasuyoshi TANAKA, Yamanashi (JP)

(21) Appl. No.: 18/269,696

(22) PCT Filed: Jan. 20, 2022
(86) PCT No.: PCT/JP2022/001962

§ 371 Date: Jun. 26, 2023

(30) Foreign Application Priority Data
Jan. 27, 2021 (JP) 2021-011421

(51) Int. Cl. B25J 9/06; B25J 15/00; B25J 18/04

(52) U.S. Cl. CPC B25J 9/06; B25J 15/0019; B25J 18/04

(57) ABSTRACT

A SCARA robot comprises: a base: a first arm mounted to the base, and capable of pivotally moving around a first joint axis with respect to the base; a second arm mounted to the first arm, and capable of pivotally moving around a second joint axis parallel to the first joint axis; an end effector mounted to the second arm; and an arm cover that is removably attached to an outer surface of the second arm, defines an outside space of the second arm that does not interfere with the first arm during pivotal movement of the second arm, and forms a storage space for rigging attached to the end effector so as to protrude from the second arm toward the first arm.

### TECHNICAL FIELD

The present invention relates to a SCARA robot.

### BACKGROUND ART

Conventionally, SCARA robots are known which are provided with an end effector such as a hand on the tip of a second arm that is provided so as to be pivotable relative to a first arm. (For example, see Patent Document 1.)

The second arm has in its interior a driving mechanism for driving the arm. This driving mechanism is covered by covers that constitute an outer shell of the second arm.
Patent Document 1: Japanese Unexamined Patent Application, Publication No. 2012-218118

### DISCLOSURE OF THE INVENTION

### Problems to be Solved by the Invention

SCARA robots may be retrofitted, as desired by a user, with rigging such as an air tube, a hand cable, etc. for driving the end effector. The end effector is located on the second arm on the opposite side from the first arm, and therefore, such rigging is provided by the user so as to protrude from the second arm toward the first arm. Therefore, depending on the manner in which the rigging is attached, there is a risk of the rigging interfering with the robot itself, such as the first arm, when the second arm pivotally moves. Accordingly, when adding rigging to the second arm, the user needs to pay close attention so that the rigging does not interfere with the robot itself, leading to poor work efficiency.

SCARA robots in which rigging is incorporated into the second arm in advance have also been proposed. However, when replacing or performing maintenance on the rigging in this type of SCARA robot, the user needs to remove the cover that covers the outside of the second arm in order to replace or perform maintenance on the rigging. Such tasks come with the risk of getting entangled with the driving mechanism inside the cover of the second arm, and thus place a heavy psychological burden on the user.

Therefore, there is a demand for allowing a user to easily retrofit rigging, without interfering with the robot itself during pivotal movement of the second arm.

### Means for Solving the Problems

One aspect of the present disclosure is a SCARA robot including: a base; a first arm provided to the base, and capable of pivotally moving around a first joint axis with respect to the base; a second arm provided to the first arm, and capable of pivotally moving around a second joint axis parallel to the first joint axis; an end effector provided to the second arm; and an arm cover that is removably attached to an outer surface of the second arm, defines an outside space of the second arm that does not interfere with the robot itself during pivotal movement of the second arm, and forms a storage space for rigging attached to the end effector so as to protrude from the second arm toward the first arm.

### Effects of the Invention

According to one aspect, it is possible to provide a SCARA robot that allows a user to easily retrofit rigging, without interfering with the robot itself during pivotal movement of a second arm.

### BRIEF DESCRIPTION OF THE DRAWINGS

FIG. 1 is a side view of a SCARA robot;

FIG. 2 is an enlarged view illustrating a fixing part for rigging inside an arm cover;

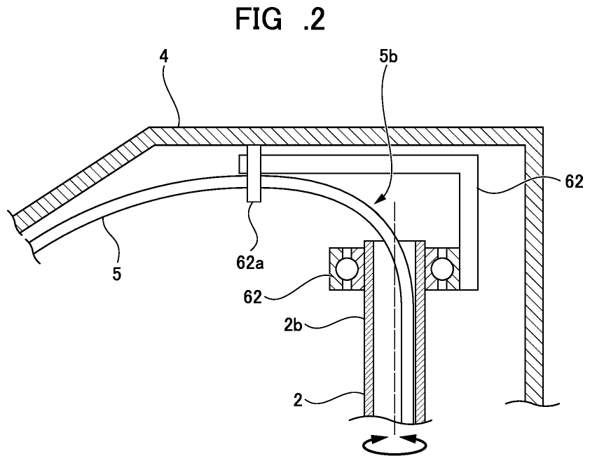

FIG. 3 is a front view seen in the X direction of the SCARA robot illustrated in FIG. 1;

FIG. 4 is a side view of the SCARA robot with the arm cover removed;

FIG. 5 is a side view of the SCARA robot provided with a control device for the end effector inside the arm cover;

FIG. 6 is a side view of the SCARA robot provided with an auxiliary cover; and

FIG. 7 is a front view seen in the X direction of the SCARA robot illustrated in FIG. 6.

### PREFERRED MODE FOR CARRYING OUT THE INVENTION

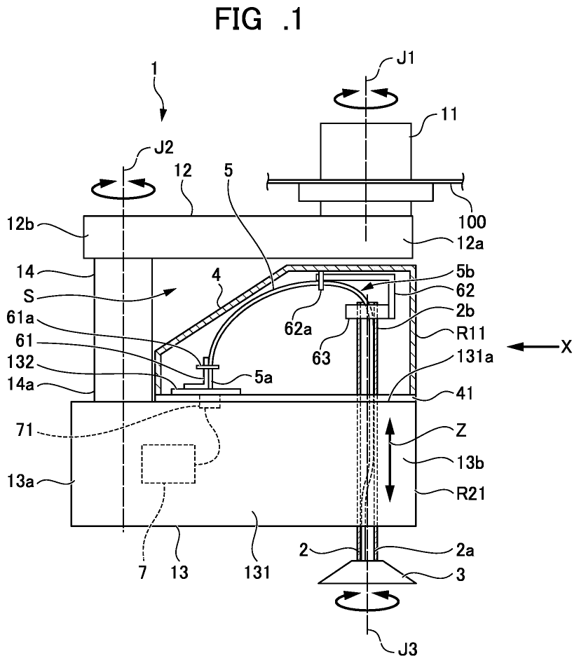

An embodiment of the present disclosure is described below with reference to the drawings. A SCARA robot 1 illustrated in FIG. 1 includes a base 11, a first arm 12 provided to the base 11, and a second arm 13 provided to the first arm 12. The SCARA robot 1 according to the present embodiment is used while being suspended from a ceiling 100, by having the base 11 be fixed to the ceiling 100.

The base 11 has a first joint axis J1 extending in a vertical direction relative to the ceiling 100. The first arm 12 is disposed so as to extend in a horizontal direction that is orthogonal to the first joint axis J1. It should be noted that the vertical direction and the horizontal direction here are used for the sake of convenience, and that extending directions other than the vertical direction and the horizontal direction may be used depending on the fixing method and usage method of the SCARA robot 1.

A base end portion 12a of the first arm 12 is attached so as to be capable of pivotally moving around the first joint axis J1 with respect to the base 11. The first arm 12 is thus provided so as to be capable of a 360° rotation around the first joint axis J1 with respect to the base 11.

A tip portion 12b of the first arm 12 has a second joint axis J2 that is parallel to the first joint axis J1. The second joint axis J2 is coaxially provided with a connecting arm 14. The connecting arm 14 extends downwardly from the tip portion 12b of the first arm 12.

The second arm 13 is provided to the tip portion 12b of the first arm 12 via the connecting arm 14. The second arm 13 is disposed so as to extend in a horizontal direction that is orthogonal to the second joint axis J2. A base end portion 13a of the second arm 13 is attached to a lower end portion 14a of the connecting arm 14 so as to be capable of pivotally moving around the second joint axis J2. Thus, the second arm 13 is disposed parallel to the first arm 12 while being downwardly spaced apart from the first arm 12, and is provided so as to be capable of a 360° rotation around the second joint axis J2 with respect to the first arm 12.

FIG. 1 illustrates a state of the SCARA robot 1 in which the second arm 13 overlaps the first arm 12 below the first arm 12. The second arm 13 is disposed downwardly spaced apart from the first arm 12, and therefore, a space S is formed between the first arm 12 and the second arm 13.

Inside the second arm 13, there is provided a driving mechanism (not illustrated) having a belt, a pulley, gears, etc. The driving mechanism is covered by an outer cover 131 that constitutes an outer shell of the second arm 13. An end effector 3 is provided on a tip portion 13b side of the second arm 13 with a hollow shaft 2 interposed therebetween. The hollow shaft 2 is constituted by a ball screw, and penetrates the second arm 13 in the up-down direction. A tip portion 2a of the hollow shaft 2 protrudes downwardly from the second arm 13. A rear end portion 2b of the hollow shaft 2 protrudes upwardly from the second arm 13 toward the first arm 12.

The end effector 3 is provided to the tip portion 2a of the hollow shaft 2. The end effector 3 is, for example, a hand, a suction cup, an assembly of suction cups, a frame supporting the same, or the like. The hollow shaft 2 is provided so as to be capable of pivotally moving around a third joint axis J3 that is parallel to the first joint axis J1 and the second joint axis J2, by the unillustrated driving mechanism inside the second arm 13. By pivotally moving around the third joint axis J3, the hollow shaft 2 moves up or down in a Z direction that follows the up-down direction. By this upward or downward movement of the hollow shaft 2, the end effector 3 is capable of moving in a protruding direction (downward) and a retracting direction (upward) with respect to the second arm 13.

An arm cover 4 is removably attached to the outer surface of the outer cover 131 of the second arm 13 by a fastening member such as a bolt or the like (not illustrated). The outer surface of the outer cover 131 to which the arm cover 4 is attached is the surface that faces the first arm 12 in the state in which the second arm 13 overlaps the first arm 12 below the first arm 12. In the SCARA robot 1 according to the present embodiment, the outer surface of the outer cover 131 to which the arm cover 4 is attached is an upper surface 131a of the outer cover 131. In the SCARA robot 1 illustrated in FIG. 1, the arm cover 4 is illustrated in a vertical cross-section.

As illustrated in FIG. 1, the arm cover 4 protrudes upwardly from the upper surface 131a of the outer cover 131 of the second arm 13. The arm cover 4 has a size that fits in the space S between the first arm 12 and the second arm 13 in the state in which the first arm 12 and the second arm 13 overlap in the up-down direction. Therefore, even when the second arm 13 with the arm cover 4 attached thereto pivotally moves around the second joint axis J2, the arm cover 4 does not interfere with the first arm 12. In other words, the arm cover 4 defines an outside space of the second arm 13 that does not interfere with the SCARA robot 1 itself during pivotal movement of the second arm 13. Specifically, the arm cover defines the outside space that does not interfere with the SCARA robot 1 itself during pivotal movement of the second arm 13 on the upper surface 131a side of the outer cover 131 of the second arm 13.

The rear end 2b side of the hollow shaft 2 penetrates the second arm 13 and protrudes upward, and is disposed inside the arm cover 4. The rear end 2b side of the hollow shaft 2 is not exposed to the outside, and therefore, the hollow shaft 2 can be protected from dust, moisture, and the like. Even when the hollow shaft 2 moves as far upward as possible, the hollow shaft 2 will not collide with the inner wall surface of the arm cover 4.

A linear member 5 is inserted through the interior of the hollow shaft 2. The linear member 5 is a type of rigging that is fitted with respect to the end effector 3 by a user. The linear member 5 connected to the end effector 3 runs through the interior of the hollow shaft 2 and is drawn out into the interior of the arm cover 4 from the rear end portion 2b of the hollow shaft 2. The linear member 5 is drawn inside the arm cover 4 so as to protrude from the second arm 13 toward the first arm 12. In other words, the arm cover 4 forms a storage space for the linear member 5 disposed so as to protrude from the second arm 13 toward the first arm 12. The linear member 5 is specifically an air tube for supplying air for driving the end effector 3, a hand cable for operating the end effector 3, or the like. The linear member 5 supplies air or drives the hand or the like along with an upward or downward movement of the hollow shaft 2.

A connecting portion 132 for the linear member 5 is provided to the upper surface 131a of the outer cover 131 of the second arm 13. The connecting portion 132 is disposed in the vicinity of the connecting arm 14, facing the interior of the arm cover 4. The connecting portion 132 is constituted by, for example, a distribution plate connecting the linear member 5 and the control device 7 disposed inside the second arm 13. The control device 7 has, for example, a solenoid valve for opening and closing the supply path of air to the end effector 3, via the linear member 5. The control device 7 is connected to the connecting portion 132 via an attachment interface 71, and is connected to the linear member 5 via the connecting portion 132. The linear member 5 has a connector (not illustrated) configured to connect to the attachment interface 71 of the control device 7 via the connecting portion 132. The user is able to connect the linear member 5 and the control device 7 inside the second arm 13 by simply connecting the connector of the linear member 5 drawn inside the arm cover 4 to the connecting portion 132 from the outside of the second arm 13. The user does not need to remove the outer cover 131 of the second arm 13 in order to connect the linear member 5 and the control device 7, and therefore will not directly touch the driving mechanism and the like inside the second arm 13.

The connecting portion 132 is provided with a first fixing member 61 configured to fix the linear member 5. The first fixing member 61 is composed of, for example, an L-shaped piece, and protrudes upwardly from the connecting portion 132. An end portion 5a on the connecting portion 132 side of the linear member 5 connected to the connecting portion 132 inside the arm cover 4 is fixed to the first fixing member 61 by a binding member 61a such as a cable tie or the like.

The rear end portion 2b of the hollow shaft 2 is provided with a second fixing member 62 configured to fix the linear member 5. The second fixing member 62 is composed of, for example, an L-shaped piece, and extends from the rear end portion 2b of the hollow shaft 2 in a direction that is orthogonal to the extending direction of the hollow shaft 2, specifically from the rear end portion 2b of the hollow shaft 2 toward the side on which the connecting portion 132 is disposed. The second fixing member 62 is attached to the rear end portion 2b of the hollow shaft 2 so as to be capable of pivotal movement, via a bearing 63 that is coaxially fixed to the hollow shaft 2. A section 5b of the linear member 5 protruding from the hollow shaft 2 into the interior of the arm cover 4 is fixed to the second fixing member 62 by a binding member 62a such as a cable tie or the like.

In this way, the linear member 5 protruding from the second arm 13 to the outside is drawn inside the arm cover 4. The arm cover 4 defines an outside space of the second arm 13 that does not interfere with the robot itself (the first arm 12) during pivotal movement of the second arm 13, and therefore, the user is able to easily retrofit the linear member 5 without interfering with the SCARA robot 1 itself during pivotal movement of the second arm 13, by drawing the linear member 5 so as to be contained inside the arm cover 4.

By drawing the linear member 5 through the first fixing member 61 and the second fixing member 62 as in the present embodiment, the user is able to easily contain the linear member 5 protruding from the second arm 13 toward the first arm 12 inside the arm cover 4. The second fixing member 62 is attached to the rear end portion 2b of the hollow shaft 2 via the bearing 63, and therefore, even when the hollow shaft 2 pivotally moves around the third joint axis J3, the second fixing member 62 will not pivotally move, and the orientation of the second fixing member 62 inside the arm cover 4 substantially does not change. Therefore, the second fixing member 62 is capable of supporting the linear member 5 inside the arm cover 4 such that the drawing direction of the linear member 5 from the rear end portion 2b of the hollow shaft 2 to the connecting portion 132 constantly follows the second arm 13. Moreover, by fixing the linear member 5 to the second fixing member 62, the linear member 5 is prevented from colliding with the inner surface of the arm cover 4 during pivotal movement of the hollow shaft 2.

The section 5b of the linear member 5 protruding from the hollow shaft 2 into the interior of the arm cover 4 may be provided with a swivel joint not illustrated here. This makes it so that a torsion stress does not occur in the linear member 5, and the linear member 5 can thus be protected from torsion stress. The swivel joint may be particularly preferably used when the linear member 5 is an air tube. When it can be determined that a collision of the linear member 5 with the inner surface of the arm cover 4 would not cause any harmful damage to the linear member 5, the second fixing member 62 may be omitted.

As illustrated in FIG. 1, the arm cover 4 according to the present embodiment is attached to the upper surface 131a of the outer cover 131 via a gasket 41. By attaching the arm cover 4 to the second arm 13 via the gasket 41, entry of dust, water, and the like into the interior of the arm cover 4 can be effectively prevented. Therefore, the hollow shaft 2, the linear member 5, the connecting portion 132, and the like inside the arm cover 4 can be more reliably protected from dust, moisture, and the like.

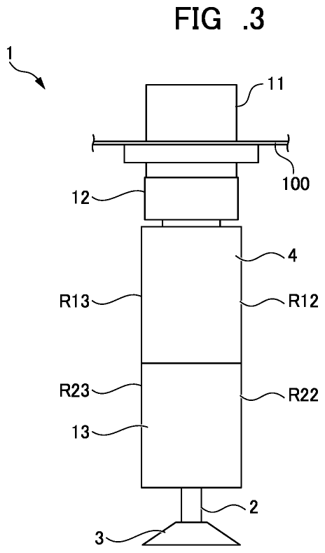

As illustrated in FIG. 1, when the SCARA robot 1 is viewed from the side, a ridge R11 that runs along the up-down direction on the tip portion 13b side of the second arm 13 on the arm cover 4 matches a ridge R21 that runs along the up-down direction on the tip portion 13b of the second arm 13, and is disposed continuously therewith. As illustrated in FIG. 3, when the SCARA robot 1 is viewed in an X direction (see FIG. 1) along the extending direction of the second arm 13, ridges R12, R13 that run along the up-down direction of the arm cover 4 match ridges R22, R23 that run along the up-down direction of the second arm 13, and are disposed continuously therewith. In other words, the ridge R11 and the ridge R21, the ridge R12 and the ridge R22, and the ridge R13 and the ridge R23 respectively form continuous ridges. This provides uniformity to the designs of the second arm 13 and the arm cover 4, and therefore, an observer will not feel a sense of wrongness even when the arm cover 4 is attached so as to protrude from the second arm 13 toward the first arm 12. It should be noted that not all the ridges of the arm cover 4 and the second arm 13 need to be continuous, and that it is sufficient that at least part of the ridges of the arm cover 4 and at least part of the ridges of the second arm 13 are continuous.

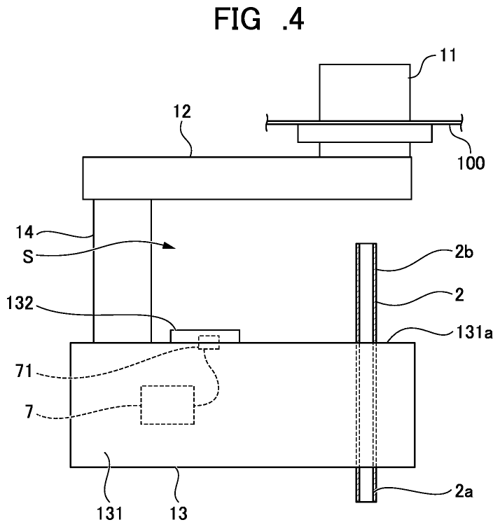

As illustrated in FIG. 4, the SCARA robot 1 prior to being provided with the end effector 3 (prior to rigging being added by a user) does not have the arm cover 4. When the user is to add the linear member 5 as rigging with the SCARA robot 1 in this state, it is enough to access the connecting portion 132 and the hollow shaft 2 that are exposed to the outside of the second arm 13, and there is no need to directly access the driving mechanism inside the second arm 13. Therefore, there is no risk of getting entangled in the driving mechanism during working, which greatly reduces the psychological burden on the user during working. Moreover, because the user does not directly touch the driving mechanism even when the arm cover 4 is removed from the second arm 13, it is safe. The connecting portion 132 is disposed inside the arm cover 4, and therefore, the linear member 5 will not be exposed to the outside. Therefore, the linear member 5 can be protected, and the linear member 5 can be prevented from getting caught or the like.

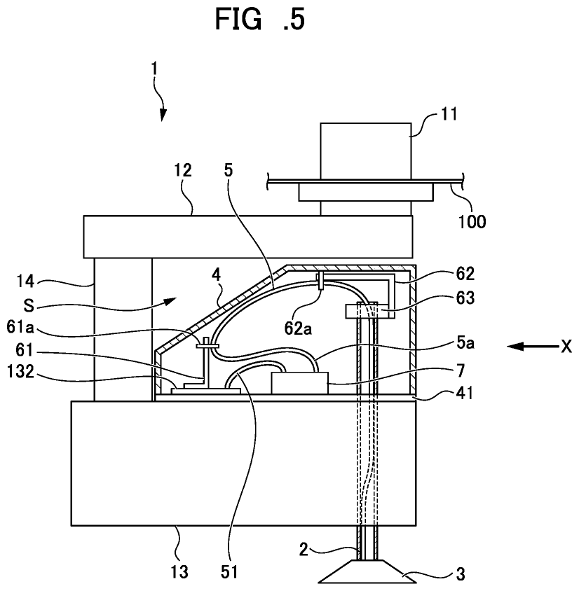

As illustrated in FIG. 5, the control device 7 that controls the end effector 3 may be disposed inside the arm cover 4. In this case, the end portion 5a on the connecting portion 132 side of the linear member 5 is connected to the control device 7. The control device 7 may be connected to the connecting portion 132 by a separate linear member 51. By disposing the control device 7 inside the arm cover 4, the control device 7 can easily be changed or added according to the type of end effector 3 and linear member 5. Even when changing or adding the control device 7, the user can easily and safely perform the changing or adding work outside the second arm 13.

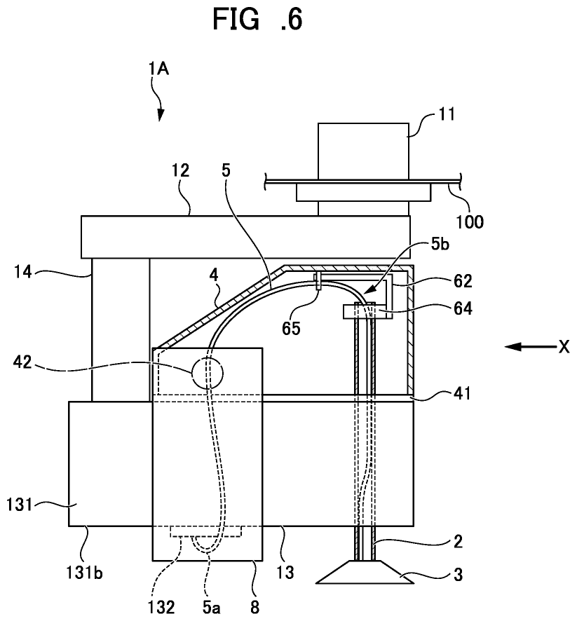

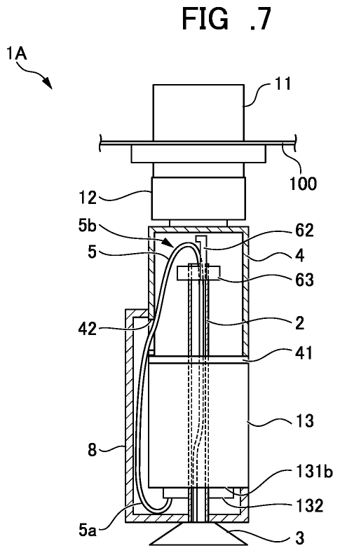

FIG. 6 and FIG. 7 illustrate a SCARA robot 1A in which the connecting portion 132 is disposed outside the arm cover 4. Parts having the same reference numerals as the SCARA robot 1 described above have identical configurations, and therefore, the above descriptions are incorporated by reference, and omitted in the following description.

The connecting portion 132 of this SCARA robot 1A is disposed on a lower surface 131b of the outer cover 131 of the second arm 13. The linear member 5 is drawn so as to extend upwardly from the connecting portion 132 passing on the outside of the second arm 13, and reach the interior of the arm cover 4 through a through-hole 42 provided in the side surface of the arm cover 4. Instead of the through-hole 42, the arm cover 4 may be provided with a notch through which the linear member 5 may be inserted.

The second arm 13 has an auxiliary cover 8 for covering the linear member 5 passing the outside of the second arm 13 from the connecting portion 132, the auxiliary cover 8 being removably attached by a fastening member such as a bolt or the like (not illustrated). The auxiliary cover 8 is provided so as to cover the entire connecting portion 132 at the lower surface 131b of the outer cover 131 of the second arm 13, extend upwardly along the side surface of the second arm 13, and cover the through-hole 42 of the arm cover 4. The linear member 5 connected to the connecting portion 132 and drawn on the outside of the arm cover 4 can be covered by the auxiliary cover 8, and therefore, the linear member 5 can be protected and prevented from getting caught or the like even when the connecting portion 132 is not disposed inside the arm cover 4.

As described above, the SCARA robot 1 according to the present embodiment exhibits the following effects. Specifically, the SCARA robot 1 according to the present embodiment includes: the base 11; the first arm 12 provided to the base 11, and capable of pivotally moving around the first joint axis J1 with respect to the base 11; the second arm 13 provided to the first arm 12, and capable of pivotally moving around the second joint axis J2 parallel to the first joint axis J1; the end effector 3 provided to the second arm 13; and the arm cover 4 that is removably attached to an outer surface of the second arm 13, defines an outside space of the second arm 13 that does not interfere with the robot itself during pivotal movement of the second arm 13, and forms a storage space for the linear member 5 as rigging attached to the end effector 3 so as to protrude from the second arm 13 toward the first arm 12. As a result, by having the linear member 5 be drawn so as to be contained inside the arm cover 4, the user is able to easily retrofit the linear member 5 without interfering with the SCARA robot 1 itself during pivotal movement of the second arm 13.

The SCARA robot 1 according to the present embodiment has, inside the arm cover 4, a first fixing member 61 and a second fixing member 62 configured to fix the linear member 5. As a result, the user is able to easily contain the linear member 5 protruding from the second arm 13 toward the first arm 12 inside the arm cover 4.

In the SCARA robot 1 according to the present embodiment, the second arm 13 has on an outer surface thereof a connecting portion 132 configured to connect the linear member 5 and a control device 7 that is disposed inside the second arm 13 and controls the end effector 3 via the linear member 5. As a result, the user is able to easily and safely connect the linear member 5 and the control device 7 inside the second arm 13 by simply connecting the linear member 5 to the connecting portion 132, without needing to directly access the interior of the second arm 13.

In the SCARA robot 1 according to the present embodiment, the connecting portion 132 is disposed inside the arm cover 4. As a result, the linear member 5 can be drawn inside the arm cover 4 without being exposed to the outside of the arm cover 4. Therefore, the linear member 5 can be protected, and the linear member 5 can be prevented from getting caught or the like.

In the SCARA robot 1 according to the present embodiment, the connecting portion 132 may be disposed on an outer surface of the second arm 13 outside the arm cover 4, and the linear member 5 may be disposed so as to pass the outside of the second arm 13 from the connecting portion 132 and reach an interior of the arm cover 4. In this case, the SCARA robot may further include an auxiliary cover 8 that covers the linear member 5 passing the outside of the second arm 13 from the connecting portion 132. As a result, the linear member 5 disposed outside the arm cover 4 can be protected and prevented from getting caught or the like by the auxiliary cover 8.

In the SCARA robot 1 according to the present embodiment, the second arm 13 has a hollow shaft 2 capable of moving with respect to the second arm 13 in a direction that is parallel to the first joint axis J1 and the second joint axis J2. The end effector 3 is provided to a tip portion 2a of the hollow shaft 2, and a rear end portion 2b of the hollow shaft 2 penetrates the second arm 13 and is disposed inside the arm cover 4. The linear member 5 is inserted through the hollow shaft 2 inside the arm cover 4 and is connected to the end effector 3. As a result, the rear end portion 2b side of the hollow shaft 2 protruding upwardly from the second arm 13 toward the first arm 12 can be covered by the arm cover 4. The hollow shaft 2 is not exposed to the outside, and therefore, the hollow shaft 2 can be protected from dust, moisture, and the like.

In the SCARA robot 1 according to the present embodiment, ridges R11, R12, R13 of the arm cover 4 are continuous with ridges R21, R22, R23 of the second arm 13. This provides uniformity to the designs of the second arm 13 and the arm cover 4, and therefore, an observer will not feel a sense of wrongness even when the arm cover 4 is attached so as to protrude from the second arm 13 toward the first arm 12.

The SCARA robot 1 according to the present embodiment is suspended from a ceiling 100 by having the base 11 be fixed to the ceiling 100. However, although not illustrated here, the SCARA robot 1 may also be provided protruding upwardly from the base 11 installed on a floor surface.

### EXPLANATION OF REFERENCE NUMERALS

1 SCARA robot
11 Base
12 First arm
13 Second arm
132 Connecting portion
2 Hollow shaft
2a Tip portion
2b Rear end portion
3 End effector
4 Arm cover
5 Linear member (rigging)
61 First fixing member
62 Second fixing member
7 Control device
8 Auxiliary cover
J1 First joint axis
J2 Second joint axis
R11, R12, R13 Ridges of the arm cover
R21, R22, R23 Ridges of the second arm

1. A SCARA robot comprising:
a base;
a first arm provided to the base, and capable of pivotally moving around a first joint axis with respect to the base;
a second arm provided to the first arm, and capable of pivotally moving around a second joint axis parallel to the first joint axis;
an end effector provided to the second arm; and
an arm cover that is removably attached to an outer surface of the second arm, defines an outside space of the second arm that does not interfere with the robot itself during pivotal movement of the second arm, and forms a storage space for rigging attached to the end effector so as to protrude from the second arm toward the first arm.

2. The SCARA robot according to claim 1, having a fixing member configured to fix the rigging inside the arm cover.

3. The SCARA robot according to claim 1, wherein
the second arm has on the outer surface thereof a connecting portion configured to connect the rigging and a control device that is disposed inside the second arm and controls the end effector via the rigging.

4. The SCARA robot according to claim 3, wherein
the connecting portion is disposed inside the arm cover.

5. The SCARA robot according to claim 3, wherein
the connecting portion is disposed on the outer surface of the second arm outside the arm cover, and
the rigging is disposed so as to pass the outside of the second arm from the connecting portion and reach an interior of the arm cover,
the SCARA robot further comprising an auxiliary cover that covers the rigging passing the outside of the second arm from the connecting portion.

6. The SCARA robot according to claim 1, wherein
the second arm has a hollow shaft capable of moving with respect to the second arm in a direction that is parallel to the first joint axis and the second joint axis,
the end effector is provided to a tip portion of the hollow shaft,
a rear end portion side of the hollow shaft penetrates the second arm and is disposed inside the arm cover, and
the rigging is inserted through the hollow shaft inside the arm cover and is connected to the end effector.

7. The SCARA robot according to claim 1, wherein
at least part of a ridge of the arm cover is continuous with at least part of a ridge of the second arm.
